(19) United States
(12) Patent Application Publication
(10) Pub. No.: US 2020/0139813 A1
(43) Pub. Date: May 7, 2020

(54) HEAD-UP DISPLAY SYSTEM

(71) Applicant: DENSO CORPORATION, Kariya-city (JP)

(72) Inventors: Sung Woo LEE, Changwon-city (KR); Jeom Sik KIM, Changwon-city (KR); Won Se OH, Changwon-city (KR); Yung Uk KO, Changwon-city (KR)

(21) Appl. No.: 16/666,514

(22) Filed: Oct. 29, 2019

(30) Foreign Application Priority Data
Nov. 1, 2018 (KR) 10-2018-0132657

(51) Int. Cl. B60K 35/00; G02B 27/01

(52) U.S. Cl. CPC B60K 35/00; G02B 27/0149; B60K 2370/334; B60K 2370/165; B60K 2370/1529

(57) ABSTRACT

A head-up display system includes: a housing embedded in an upper portion of a dashboard of a vehicle; a controller that receives driving information from the vehicle and stores the driving information; a video output unit that is installed inside the housing and receives the driving information from the controller to output and project a plurality of separated videos; and an optical unit that is installed inside the housing and configured to change an optical path of each of the images projected from the video output unit, so that respective images are projected and displayed at different projection distances on a windshield of the vehicle.

### CROSS REFERENCE TO RELATED APPLICATION

The present application claims the benefit of priority from Korean Patent Application No. 10-2018-0132657 filed on Nov. 1, 2018. The entire disclosures of the above application are incorporated herein by reference.

### TECHNICAL FIELD

The present disclosure relates to a head-up display system for a vehicle.

### BACKGROUND

For example, a head-up display (HUD) for effectively transmitting information, such as vehicle driving information and surrounding situation information, to the driver is installed in a vehicle.

### SUMMARY

The present disclosure describes a head-up display system that includes a housing, a controller, a video output unit, and an optical unit, and in which an overall size can be miniaturized by outputting a plurality of videos by the video output unit so as to maximize space utilization inside a dashboard of a vehicle, and in which various pieces of driving information are respectively displayed by a plurality of videos so that a driver can easily check the driving information.

### BRIEF DESCRIPTION OF DRAWINGS

FIG. 1 is an exemplary view illustrating a state in which driving information of a vehicle is displayed on a windshield through a head-up display of a vehicle of a related art;

FIG. 2 is a schematic view illustrating a state in which the head-up display is installed on a dashboard of a general vehicle;

FIG. 3 is a perspective view illustrating an example of a head-up display system according to the present disclosure;

FIG. 4 is a side view of the example of FIG. 3 as viewed from a side thereof;

FIG. 5 is an exploded view illustrating a liquid crystal module of a video output unit in the example of FIG. 3;

FIG. 6 is a conceptual view illustrating a process for a driver recognizing a planar image output through an A region of the liquid crystal module in the example of FIG. 5;

FIG. 7 is a conceptual view illustrating a process for the driver recognizing a three-dimensional image output through a B region of the liquid crystal module in the example of FIG. 5;

FIG. 8 is a block diagram illustrating a configuration of a controller in the example of FIG. 3;

FIGS. 9 to 11 are exemplary views illustrating a state in which the image output from each of the A region and the B region of the liquid crystal module through the video output setting unit is individually turned on/off in the example of FIG. 8;

FIG. 12 is a block diagram illustrating a configuration of the controller including a projection distance adjusting unit in the example of FIG. 8;

FIGS. 13 and 14 are conceptual views illustrating a process of adjusting a projection distance of the image output from each of the A region and the B region of the liquid crystal module by controlling the optical path of the optical unit through the projection distance adjusting unit in the example of FIG. 12;

FIG. 15 is a perspective view illustrating a state in which a binocular detection sensor is installed in the example of FIG. 3;

FIG. 16 is a block diagram illustrating a configuration of the controller including an image formation adjusting unit to control the optical unit through the binocular detection sensor in the example of FIG. 15;

FIGS. 17 to 20 are conceptual views illustrating a state of controlling the optical path of the optical unit, so that the image output through the B region of the liquid crystal panel is recognized as a three-dimensional image when both eyes of the driver move in the example of FIG. 15;

FIG. 21 is a perspective view illustrating a state in which a region setting sensor is installed in the example of FIG. 15;

FIG. 22 is a block diagram illustrating a configuration of the controller including a region setting detection unit for controlling the optical unit through the region setting sensor in the example of FIG. 21;

FIG. 23 is a conceptual view illustrating a state in which the driver is located within a tracking region of the region setting sensor in the example of FIG. 21;

FIG. 24 is a conceptual view illustrating a state in which the driver moves within the tracking region of the region setting sensor in the example of FIG. 23; and

FIG. 25 is a conceptual view illustrating a state in which the driver moves out of the tracking region of the region setting sensor in the example of FIG. 23.

### DETAILED DESCRIPTION

When considering a space where people live in everyday life, it can be roughly divided into three categories of home, a workplace, and a moving space. In particular, a vehicle occupies most of the moving space.

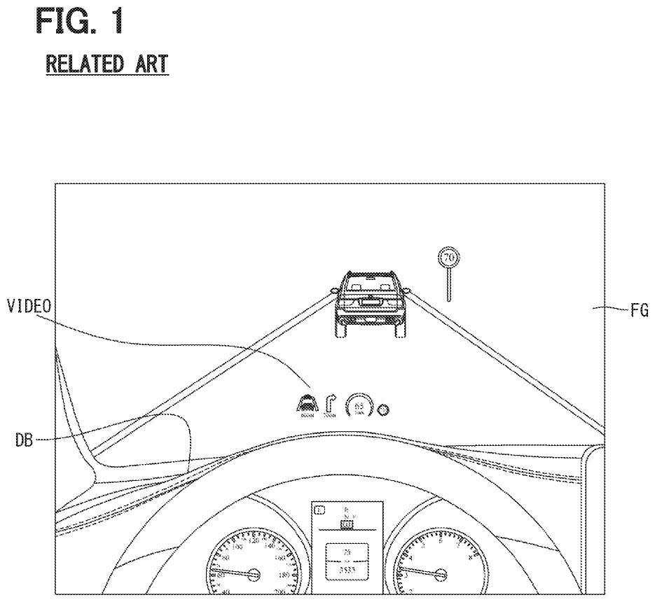

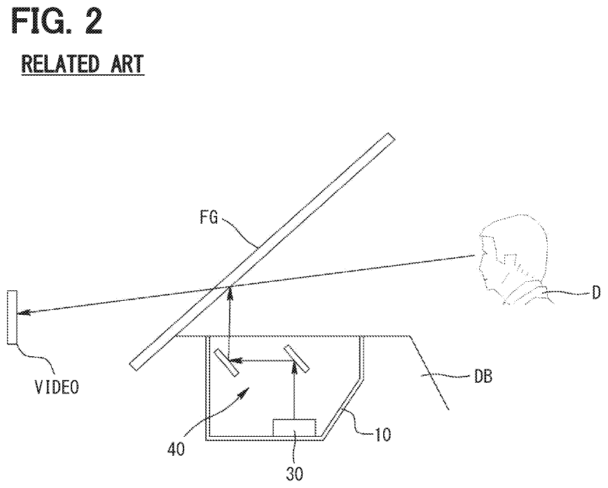

Such a vehicle is equipped with an instrument panel that displays various pieces of information related to the driving state of the vehicle. The instrument panel is constituted of a speedometer displaying a current driving speed of the vehicle, a fuel gauge displaying an amount of fuel remaining in a fuel tank of the vehicle, and a thermometer displaying a temperature, and various warning lights. As illustrated in FIGS. 1 and 2 as a related art, a driver D looks at the instrument panel to grasp a state of the currently driving vehicle so as to safely drive the vehicle. Therefore, the instrument panel is installed in front of the driver D, that is, in a dashboard so that the driver D can easily grasp a situation while driving.

However, when the driver D drives the vehicle, the field of view of the driver is directed toward a windshield FG of the vehicle, and the field of view of the driver frequently moves to the dashboard to check the instrument panel to confirm driving information and a running state of the vehicle. In this case, the eyes of the driver D look at a long distance through the windshield FG, and looks at a short distance to check the instrument panel. That is, if the driver D frequently checks the instrument panel in order to confirm the running state of the vehicle while driving, a change in a focal length of the eyes increases, thereby causing fatigue. In particular, if the driver D does not confirm the field of view of the front of the vehicle while looking at the instrument panel during driving the vehicle, a probability of accidents increases.

In order to secure the driving safety of the driver D, a head-up display (HUD) for effectively transmitting vehicle driving information and surrounding situation information to the driver is installed in the vehicle.

The head-up display of the vehicle is a display device that provides vehicle driving information or other information in front of the driver, that is, in a visible region of the driver while driving. In the early days, the head-up display was developed to be attached to an airplane, especially a fighter airplane, and recently, the head-up display has begun to be installed in the vehicle.

In general, when the driving speed of the vehicle is 100 km/h, it takes substantially 2 seconds for the driver D to fix the field of view to the front of the vehicle after checking the instrument panel. In this case, the vehicle moves substantially 55 m. That is, the faster the vehicle is driven, the more dangerous it is for the driver D to move the field of view to check the instrument panel. One method of reducing such a risk is to introduce a head-up display in the vehicle. As illustrated in FIG. 1, the head-up display of the vehicle displays information of the instrument panel on the windshield FG of the vehicle, thereby allowing the driver D to easily grasp driving information even while driving. Therefore, the driver D can maintain driving safety by recognizing the driving information of the vehicle without moving the field of view from the front.

FIG. 2 is a schematic view illustrating a state in which the head-up display according to the related art is installed in a dashboard DB of the vehicle. The head-up display includes a housing 10 embedded in an upper portion of the dashboard DB of the vehicle; a controller 20 that receives driving information from the vehicle and stores the driving information; a video output unit 30 that is installed inside the housing 10 and receives the driving information from the controller 20 to output and project a video; and an optical unit 40 that is installed inside the housing 10 and configured to change an optical path of the video projected from the video output unit 30, so that the video is projected and displayed on the windshield FG of the vehicle. Accordingly, the driving information of the vehicle is displayed by the head-up display as a planar image on the windshield FG.

In the early days, the head-up display of the vehicle displayed only the information of the vehicle displayed on the instrument panel of the vehicle, but as various devices for the convenience of the driver D are installed in the vehicle, the information displayed through the head-up display has also been diversified.

For example, for the convenience of the driver D, a navigation is installed in the vehicle to guide a road to a destination where the driver D wants to move with the vehicle. In this case, the navigation is installed on a side of the instrument panel, and the driver D is driving the vehicle while checking the road guided by the navigation. That is, the driver D moves the field of view to check the navigation, which creates a same dangerous situation as moving of the field of view of the driver D to check the instrument panel. Accordingly, the navigation information is displayed on the windshield FG of the vehicle by interlocking the head-up display of the vehicle with the navigation, so that the driver D does not move the field of view while driving.

In addition, the vehicle is provided with various sensors for the driving convenience of the driver D. In this case, as a representative, there is a distance detection sensor for detecting a distance to a vehicle driving in front of the related vehicle to guide the driver D. When the vehicle is driven at a high speed, such a distance detection sensor is required to slow down or stop the vehicle by identifying a dangerous situation in front of the vehicle or an obstacle element against the driving. The vehicle is stopped after moving a certain distance due to the driving speed in a forward direction. That is, when the preceding vehicle suddenly stops while driving, an accident may occur due to a braking distance. Therefore, in order to suppress such an accident, a distance detection sensor is installed to detect the distance from the vehicle to the preceding vehicle and informs the driver D of the distance to secure a sufficient braking distance. The distance from the windshield FG of the vehicle to the preceding vehicle is displayed by interlocking the head-up display with the distance detection sensor. Therefore, the driver D safely drives without moving the field of view while driving.

In addition, due to the development of technology, various sensors are attached to the vehicle to secure driving safety of the vehicle as well as the convenience of the driver D. That is, as illustrated in FIG. 1, the head-up display, which is currently used, displays various pieces of information on the windshield FG of the vehicle by interlocking with sensors and devices which are installed in the vehicle, and provide various pieces of information. In this case, the head-up display is limited in size by being embedded in the dashboard DB of the vehicle, and the driving information has to be displayed in a range that does not interfere with the field of view of the driver D. Therefore, the information displayed through the head-up display, that is, the number of pieces of information to be displayed in one video is increased, and a magnitude of the displayed information is reduced not to disturb the field of view of the driver D. This is a problem that it is difficult for the driver D to check the driving information while driving the vehicle.

In addition, in the information displayed by the head-up display of the vehicle, as illustrated in FIG. 1, information identification may be difficult because a large amount of information must be displayed in one video. For example, as illustrated in FIG. 1, when the information of the distance detection sensor, the information of the navigation, the information of the instrument panel, and the information of the road currently driving are displayed at once, it may be difficult for the driver D to quickly determine what information each figure is about.

In order to solve the above issues, if the head-up display of the vehicle includes a plurality of videos output units 30 to output a plurality of videos, the front, rear, left and right lengths of the housing 10 of the head-up display, that is, the size of the head-up display may be increased. As a result, an installation region embedded in the dashboard (DB) of the vehicle may be widened, which hinders space utilization inside the dashboard (DB) of the vehicle.

The present disclosure provides a head-up display system, an overall size of which can be miniaturized by outputting a plurality of videos by one video output unit so as to maximize space utilization inside a dashboard of a vehicle, and in which various pieces of driving information are respectively displayed by a plurality of videos so that a driver can easily check the driving information.

According to a first aspect of the present disclosure, there is provided a head-up display system including: a housing to be embedded in an upper portion of a dashboard of a vehicle; a controller that receives driving information from the vehicle and stores the driving information; a video output unit that is installed inside the housing and is configured to receive the driving information from the controller and to output and project a plurality of separated videos; and an optical unit that is installed inside the housing and is configured to change an optical path of each of videos projected from the video output unit, so that respective videos are projected and displayed at different projection distances on a windshield of the vehicle.

According to a second aspect of the present disclosure, the video output unit may include a liquid crystal module that includes a liquid crystal panel and a backlight unit disposed on a back of the liquid crystal panel. The liquid crystal panel may include a first region for outputting the driving information received from the controller as a planar image and a second region for outputting the driving information as a three-dimensional image.

According to a third aspect of the present disclosure, the liquid crystal module may be provided with a parallax barrier film such that, when the driving information is output as an image through the second region of the liquid crystal panel, the image output according to a binocular parallax of left and right eyes of a driver is separated into a left eye image and a right eye image different from each other to be displayed as a three-dimensional image.

According to a fourth aspect of the present disclosure, the controller may include a video output setting unit that is configured to receive a control signal from the video output unit and to individually turn on or off each image output from each of the first region and the second region of the liquid crystal module.

According to a fifth aspect of the present disclosure, the controller may further include a projection distance adjusting unit that is configured to control an optical path of the optical unit to adjust a projection distance of the image when the image output from each of the first region and the second region of the liquid crystal module is displayed on the windshield of the vehicle through the video output unit.

According to a sixth aspect of the present disclosure, the head-up display system may further include a binocular detection sensor that is configured to detect movements of the left and right eyes of the driver. The controller may further include an image formation adjusting unit that is configured to receive a signal from the binocular detection sensor and to control the optical path of the optical unit, so that the image output from the second region of the liquid crystal panel is displayed for the driver as a three-dimensional image according to the movements of the left and right eyes of the driver.

According to a seventh aspect of the present disclosure, the head-up display system may further include a region setting sensor that is configured to photograph a fixed tracking region including a face of the driver in a driver's seat of the vehicle. The controller may further include a region setting detection unit that is configured to set a tracking region of the region setting sensor and to control the optical path of the optical unit, so that the image output from the second region of the liquid crystal panel is displayed at a preset setting position when the face of the driver leaves the tracking region.

In the head-up display system according to the present disclosure, the liquid crystal panel of the liquid crystal module may be divided into at least two regions such as the first region and the second region, and the driving information may be displayed through two videos. In such a case, it is possible to provide various pieces of driving information to the driver while displaying an image of the driving information in a size that is easy for a driver to recognize.

The parallax barrier film may be attached to the second region of the liquid crystal panel to display the video output from the second region as a three-dimensional image. In such a case the driver can easily recognize the driving information.

The optical path of the optical unit may be controlled by the binocular detection sensor and the image formation adjusting unit of the controller. Even when a posture or a field of view of the driver is moved, it is less likely that the three-dimensional image output through the second region of the liquid crystal panel will be separated and recognized as two images. Therefore, the driver can easily recognize the three-dimensional image.

For example, the head-up display system of the present disclosure provides vehicle driving information or other information in front of a driver while driving a vehicle, that is, in a range without departing from a main field of view line of a driver, as a display device of a vehicle, which displays various pieces of information to the driver, such as a speed of the vehicle, a fuel amount, a temperature, and a warning display.

Hereinafter, embodiments of the head-up display system of the present disclosure will be described in detail with reference to the accompanying drawings.

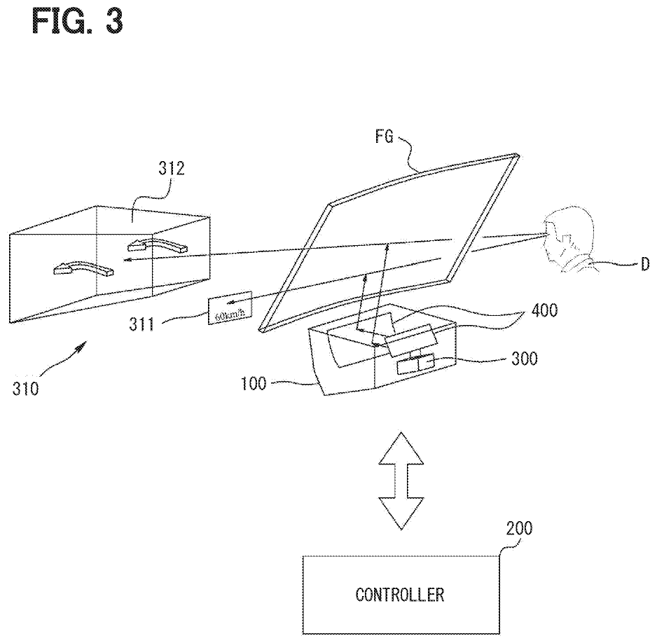

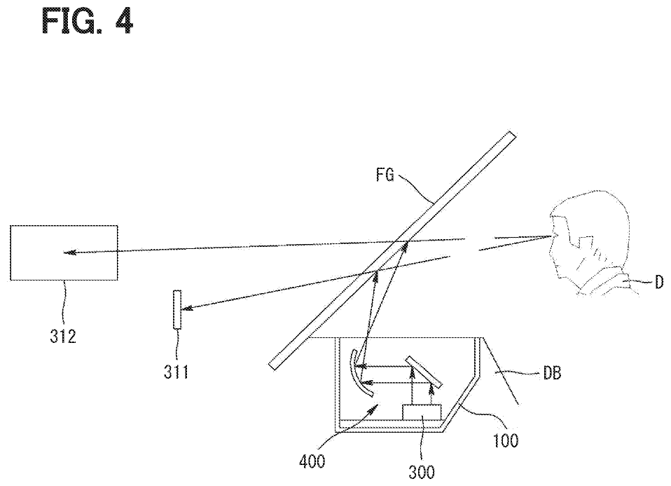

As illustrated in FIGS. 3 and 4, the head-up display system according to an embodiment of the present disclosure includes a housing 100, a controller 200, a video output unit 300, and an optical unit 400.

As illustrated in FIGS. 3 and 4, the housing 100 is embedded in an upper portion of a dashboard DB of the vehicle, in which an upper side is opened. The housing 100 is assembled in a state where the upper side is opened in a box shape in which various components to be described later are mounted and coupled inside. In this case, although not illustrated in the figure, the housing 100 may be formed of a light transmissive material that transmits light, and may further include a window cover (not illustrated) for closing the opened upper side of the housing 100.

As illustrated in FIG. 3, the controller 200 receives driving information from the vehicle and stores the driving information, and various electronic devices are mounted thereon to control a video output of the video output unit 300 which is described later. In this case, the controller 200 may be a module made of a circuit board and installed on an inner bottom surface of the housing 100, or may be provided separately to receive the driving information of the vehicle from an ECU of the vehicle. In addition, as long as the driving information of the vehicle is provided to the video output unit 300 through the ECU of the vehicle, the controller 200 may be any device capable of receiving the driving information from the vehicle to store the driving information.

As illustrated in FIGS. 3 and 4, the video output unit 300 is installed inside the housing 100 and receives the driving information from the controller 200 to output and project a plurality of separated videos 310. The video output unit 300 generates and outputs a related video based on a video signal and a control signal applied from the controller 200. In this case, the video signal is a signal corresponding to vehicle information and the driving information, such as instrument panel information of the vehicle, navigation information, and various pieces of information collected from various sensors of the vehicle. That is, the video output unit 300 outputs and projects various pieces of information in a plurality of separated videos 310, thereby distributing various pieces of information displayed in the videos 310 to lower a density. Therefore, the images can be displayed in size capable of being easily recognized by the driver D.

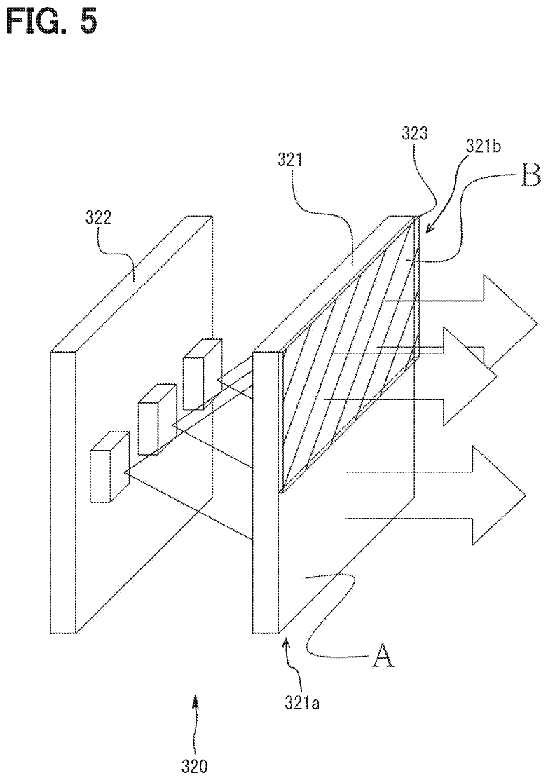

In addition, as illustrated in FIG. 5, the video output unit 300 includes a liquid crystal module 320 having a liquid crystal panel 321 and a backlight unit 322 disposed in a back surface of the liquid crystal panel 321. That is, light is generated by the backlight unit 322, and the generated light passes through the liquid crystal panel 321 to project the plurality of separated videos 310. In this case, the liquid crystal panel 321 is provided with a liquid crystal display (LCD) or a display device such as PDP or OLED. Therefore, the video output unit 300 outputs a plurality of videos through one liquid crystal module 320, thereby minimizing an overall size of the device to maximize space utilization in the inside of the dashboard DB of the vehicle.

As illustrated in FIG. 4, the video output unit 300 projects the output video 310 upward. An optical path of the video 310 projected upward from the video output unit 300 is changed through an optical unit 400 (described later), so that the video 310, which is recognizable by the driver D while driving, is displayed on the windshield FG of the vehicle.

As illustrated in FIGS. 3 and 4, the optical unit 400 is installed inside the housing 100 and the optical path of each of the videos 310 projected from the video output unit 300 is changed. Therefore, respective videos 310 are projected at different projection distances to be displayed onto the windshield FG of the vehicle. In this case, as illustrated in FIG. 4, the optical unit 400 includes a planar mirror (not illustrated) which is installed on the upper portion of the video output unit 300, and on which the video 310 projected from the video output unit 300 is reflected in front of the housing 100, and a concave mirror (not illustrated) which is installed in a front inside of the housing 100, and on which the video 310 reflected from the planar mirror is reflected upward the housing 100 to display the video 310 projected from the video output unit 300 on the front windshield FG.

That is, the optical unit 400 is configured to reflect the light. Therefore, the optical unit 400 has a function of changing each optical path of each video 310, so that the plurality of separated videos 310 projected through the video output unit 300 are positioned within the field of view in front of the driver D.

Meanwhile, when the plurality of separated videos 310 are output through the video output unit 300, various pieces of information are displayed not in one video 310 but by being divided into the plurality of videos 310. Therefore, there is an advantage that an information image displayed on the video 310 can be displayed in a size capable of being easily recognized by the driver D. In a case of the driving information in which the information images displayed by the videos 310 are displayed as information images at the same time, such as a speed of the vehicle, a prescribed speed of the road on which the vehicle is driven, a distance to a preceding vehicle, and a current time, the driver D checks the driving information with a numerical value displayed on the video 310. That is, even if the driving information described above is displayed in a two-dimensional image, the driver D can check the information without difficulty.

However, when information such as navigation information that guides a location of roads that need to pass in order to reach a destination is displayed as a two-dimensional image, there is a problem that the displayed information may be interpreted by an empirical determination of the driver D.

For example, in a case in which the navigation guide information is displayed as the two-dimensional image on the windshield FG through the video output unit 300, and the information displayed in the two-dimensional image is information to instruct to turn the right in the front of 500 m, the distance information of 500 m can be differently determined depending on the driver D. Therefore, the vehicle can turn to the right before 500 m distance and enters a wrong road, or can turn to the right after 500 m and enters a wrong road. Therefore, in this case, a probability that the vehicle enters a wrong road is higher than a case where the driver D directly checks the navigation and drives the vehicle.

In the case of information in which numerical information is to be directly displayed together with image information, such as navigation information, if the information is displayed only by two-dimensional images, the driver D cannot recognize accurate information. However, if the information is displayed as a three-dimensional virtual image, the three-dimensional virtual image is displayed as if it is located on a road in front of the vehicle, so that the driver D can recognize more accurate information.

For example, as described above, if the navigation guide information is information indicating that the vehicle has to turn to the right in front of 500 m, a virtual road indicating that the vehicle has to turn to the right can be displayed in a three-dimensional virtual image on an actual road viewed by the driver D. Therefore, a probability that the driver D enters a wrong road becomes low, which has an effect of providing accurate driving information to the driver D.

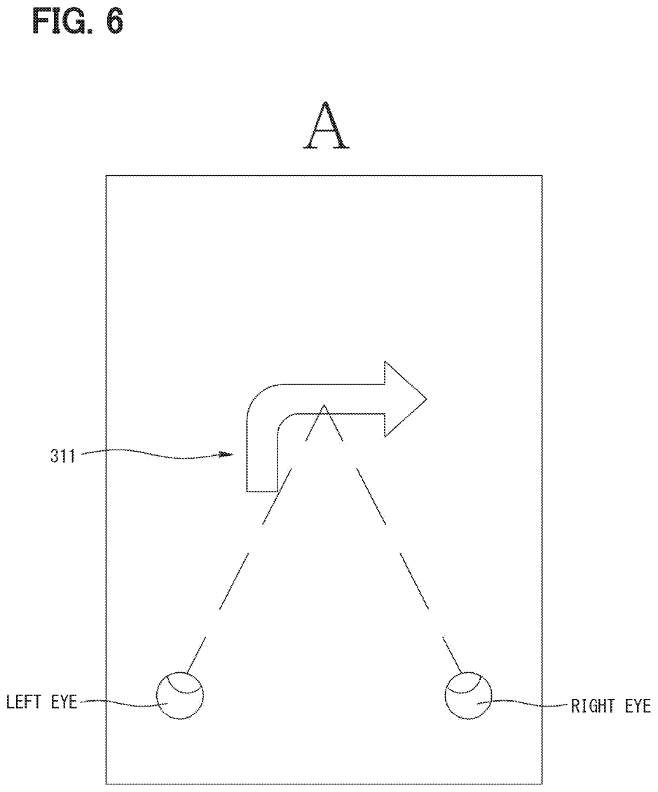

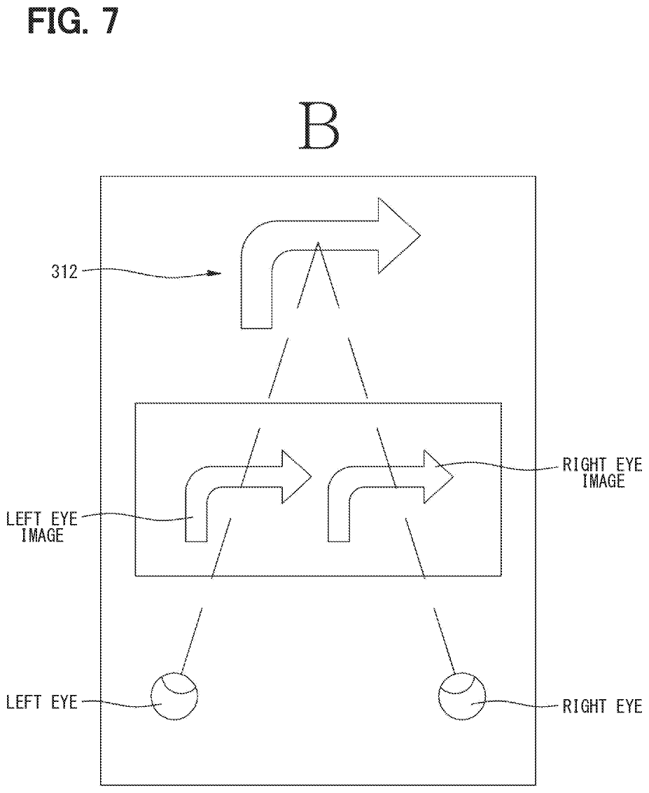

That is, when the three-dimensional virtual image of the videos 310 output through the video output unit 300 is output, not only an amount of information provided to the driver D can be increased but also accurate information can be provided. Accordingly, the liquid crystal panel 321 of the video output unit 300 may be divided into an A region 321a for outputting the driving information received from the controller 200 as a planar image 311 as illustrated in FIGS. 5 and 6, and a B region 321b for outputting the driving information as a three-dimensional image 312 as illustrated in FIGS. 5 and 7. Namely, the liquid crystal panel 321 may include the A region 321a as a first region and the B region 321b as a second region.

In this case, as illustrated in FIG. 5, a parallax barrier film 323 is attached to the B region 321b of the liquid crystal panel 321. Therefore, if the driving information is output as an image, the image output according to the binocular parallax between the left and right eyes of the driver D is output as the three-dimensional image 312 by being separated to a left eye image and a right eye image which are different from each other.

Here, the binocular parallax means a phenomenon in which in order for a person to stereoscopically recognize an object, each of the left and the right eyes obtains different visual information for one object, thereby recognizing a stereoscopic sense of the object, and the left and the right eyes obtain different information. That is, the parallax barrier refers to a method of separating one image of the output video 310 into a left eye image and a right eye image which are different from each other as illustrated in FIG. 7, so that the videos 310 that are formed by the binocular parallax in the left and right eyes to be output are displayed as the three-dimensional image 312 having the stereoscopic sense. The parallax barrier film 323 refers to a film capable of displaying the three-dimensional image 312 by the parallax barrier method described above.

Accordingly, the video output unit 300 implements the A region 321a for outputting the planar image 311 and the B region 321b for outputting the three-dimensional image 312 by one liquid crystal panel 321, and thereby the device can be miniaturized. The driving information of the vehicle are separated to be displayed by the planar image 311 and the three-dimensional image 312, and thereby the driver D can recognize the displayed driving information more accurately.

In addition, since respective images 311 and 312 are displayed by the separated videos 310, the information image having a size capable of being easily recognized by the driver D can be displayed. Therefore, there is an advantage that the driver D can easily check the driving information projected through the video output unit 300.

On the other hand, there is a situation in which the driving information of the vehicle may not be displayed on the windshield FG of the vehicle, such as a case in which the driver D wants to go to a destination located near by driving the vehicle, or a case in which the driver D determines that the three-dimensional image 312 output from the B region 321b of the liquid crystal panel 321 interferes with driving. In particular, in the case of the three-dimensional image 312 output from the B region 321b of the liquid crystal panel 321, the front of the field of view may be disturbed or dizziness may occur depending on the age of the driver D when the three-dimensional image 312 is recognized. That is, when the driver D determines that the driving information of the vehicle displayed on the windshield FG of the vehicle is unnecessary, a situation occurs in which the respective images 311 and 312 output from the video output unit 300 are set not to be displayed on the windshield FG of the vehicle.

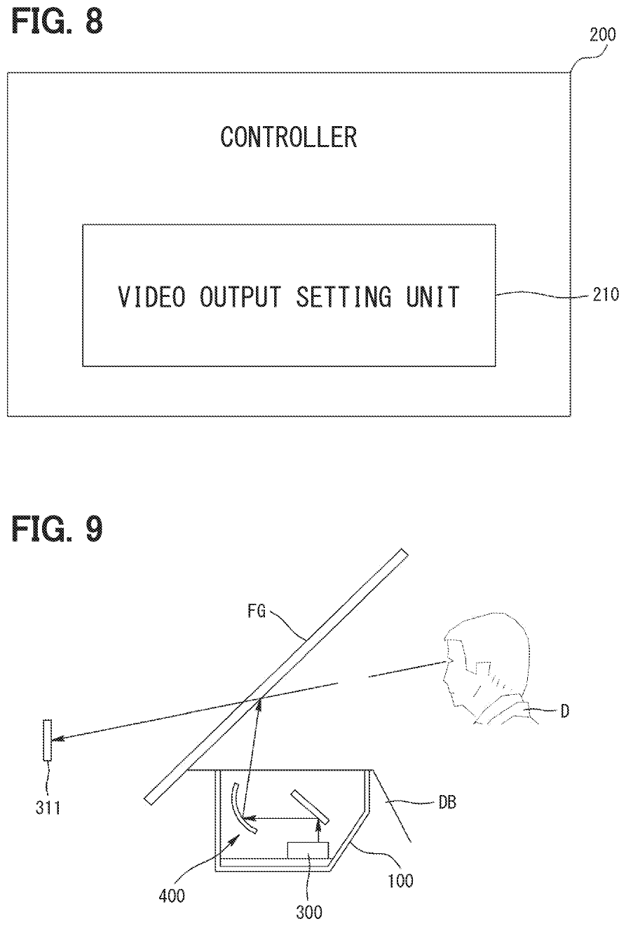

Accordingly, as illustrated in FIG. 8, the controller 200 includes a video output setting unit 210 configured to receive a control signal from the video output unit 300. Therefore, the respective images 311 and 312 output from the A region 321a and the B region 321b of the liquid crystal module 320 are individually turned on/off. In this case, an operation button (not illustrated) which the driver D pushes to operate may be provided to a steering wheel or a center fascia of the vehicle so that the driver D may easily operate the operation button. That is, if the driver D pushes the operation button before driving or during driving to turn off each of the images 311 and 312 output from the video output unit 300, the driver D may turn off each of the image 311 and 312 output from the video output unit 300 through the video output setting unit 210.

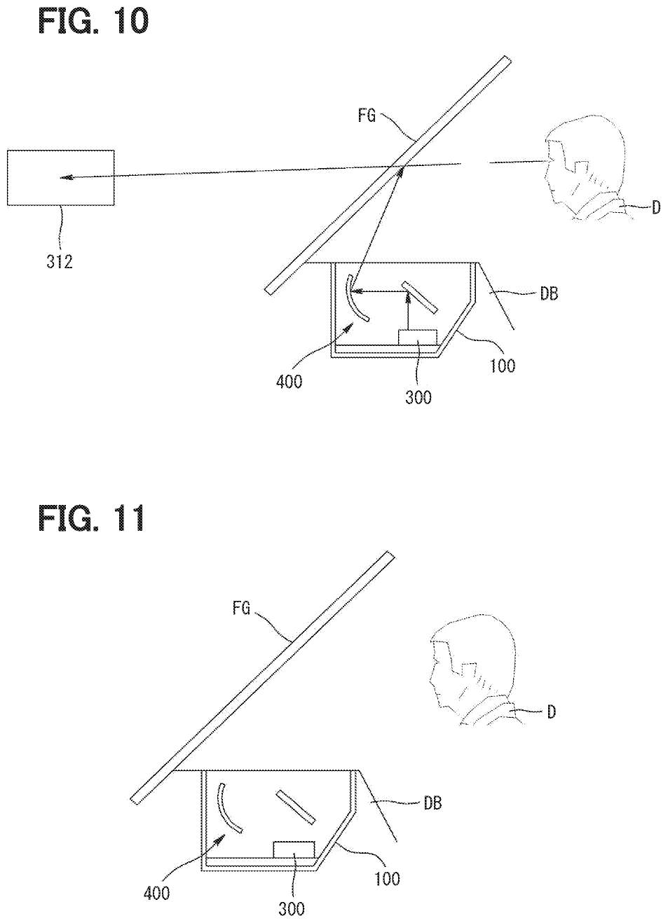

Here, the video output setting unit 210 may generate a control signal using one operation button or may generate the control signal using a plurality of operation buttons. For example, in a case in which one operation button is provided, when the driver D pushes the operation button once, as illustrated in FIG. 9, the three-dimensional image 312 output from the B region 321b of the liquid crystal panel 321 may be turned off. When the driver D pushes the operation button twice, as illustrated in FIG. 10, the planar image 311 output from the A region 321a of the liquid crystal panel 321 may be turned off. When the driver D pushes the operation button three times, as illustrated in FIG. 11, all of the images 311 and 312 output from the video output unit 300 may be turned off. When the driver D pushes the operation button for a long time, all of the images 311 and 312 may be output from the video output unit 300.

In addition, a plurality of operation buttons, that is, a first button for turning on/off of the planar image 311 output from the A region 321a of the liquid crystal panel 321, and a second button for turning on/off of the three-dimensional image 312 output from the B region 321b of the liquid crystal panel 321 are provided. Therefore, the video output setting unit 210 can also generate a control signal for turning on/off each of the images 311 and 312 output from the video output unit 300. For example, in a case in which all of the images 311 and 312 are output from the video output unit 300, when the driver D pushes the first button, as illustrated in FIG. 10, only the three-dimensional image 312 may be output, when the driver D pushes the second button, as illustrated in FIG. 9, only the planar image 311 may be output, and when the driver D respectively pushes all the first and second buttons, as illustrated in FIG. 11, all of the images 311 and 312 output from the video output unit 300 may be turned off. In this case, when the driver D respectively pushes the first and second buttons again, the video output setting unit 210 generates a control signal, so that the respective images 311 and 312 are output again.

Accordingly, the driver D can turn off the information of the image determined to be obstructed by turning on/off unnecessary image information through the video output setting unit 210. Therefore, it is possible to improve driving safety.

As described above, each of the images 311 and 312 output from the video output unit 300 may disturb the driving depending on the driver D because the conditions of the driver D in the vehicle are different from each other. That is, the driving conditions of the vehicle change depending on the driver D. For example, if the driver D having a long height rides in the vehicle, the driver D lowers a seat height of the vehicle in order to secure the field of view in front of the vehicle, and adjusts the seat position to easily operate each pedal which is operated by a pedaling force of a leg of the driver D. On the contrary, if the driver D having a short height rides in the vehicle, the driver D raises the seat height of the vehicle to secure the field of view in front of the vehicle, and adjusts the seat position toward the dashboard (DB) of the vehicle more than the driver D having a long height to easily operate each pedal which is operated by the pedaling force of the leg of the driver D.

As described above, in order to increase driving safety, the conditions required for the driver D are different from each other. That is, it is necessary to adjust the respective images 311 and 312 output through the video output unit 300 to be displayed at a position that is easy to check depending on the driver D.

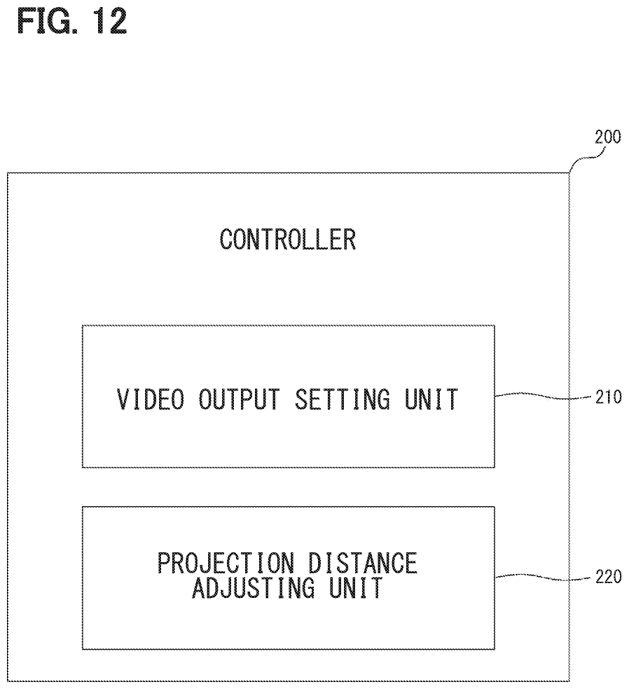

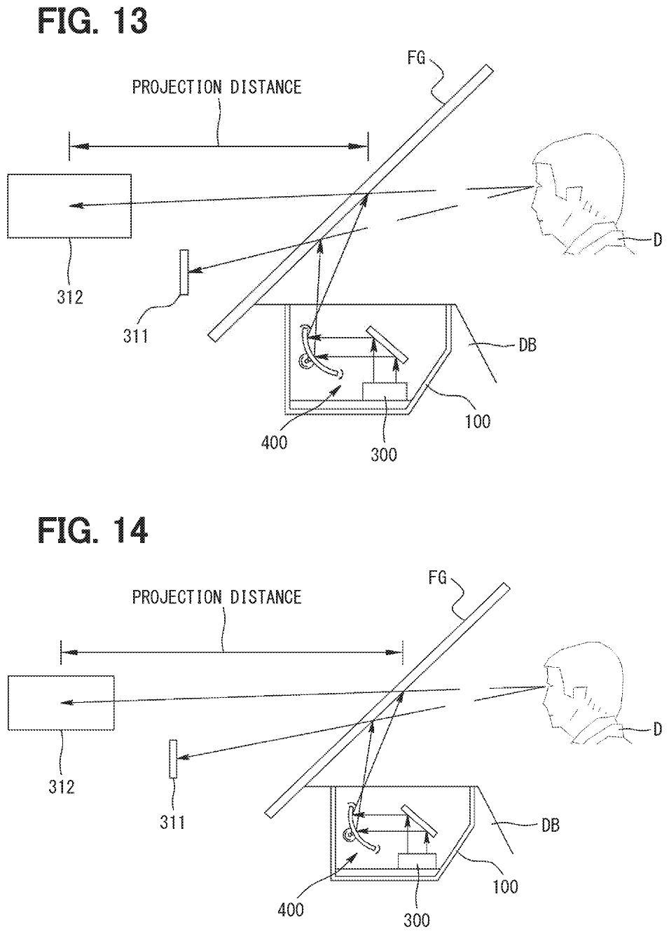

Accordingly, as illustrated in FIG. 12, the controller 200 may further include a projection distance adjusting unit 220 for controlling the optical path of the optical unit 400 to adjust the projection distance of the image in a case in which the image output from each of the A region 321a and the B region 321b of the liquid crystal module 320 is displayed on the windshield FG through the video output unit 300. That is, as illustrated in FIGS. 13 and 14, the projection distance is adjusted by changing the optical path of the optical unit 400 depending on the driver D, so that each of the images 311 and 312 output from the video output unit 300 is displayed at a position at which each of the images 311 and 312 is easily checked. In this case, as illustrated in FIG. 13, the optical unit 400 may further include a rotation motor (not illustrated) for rotating the concave mirror according to a control signal of the projection distance adjusting unit 220 to adjust the projection distance of the image displayed on the windshield FG of the vehicle.

That is, as illustrated in FIGS. 13 and 14, the optical unit 400 is controlled by the projection distance adjusting unit 220 so that the position at which the video 310 output from the video output unit 300 reaches the front windshield FG of the vehicle is adjusted. Therefore, the driver D can manipulate the optical unit 400, so that the respective images 311 and 312 are displayed at positions which are easily recognized. Here, as described above, the projection distance of the image output from the video output unit 300 can be adjusted by rotating the concave mirror, or the projection distance of the image output from the video output unit 300 can be adjusted by rotating the plane mirror of the optical unit 400.

Therefore, the projection distance adjusting unit 220 adjusts the projection distance of the image output from the video output unit 300. Therefore, the driver D can easily check respective images 311 and 312, and driving safety can be improved.

On the other hand, in the case of the image output from the B region 321b of the liquid crystal panel 321, the stereoscopic sense is recognized by the binocular parallax of the driver D and is recognized as the three-dimensional image 312. That is, when an angle, at which the driver D looks each of the left eye image and the right eye image output from the B region 321b of the liquid crystal panel 321, is changed, the driver D does not recognize the images as the three-dimensional image 312, but recognizes as separated images of left eye image and the right eye image. For example, when the body of the driver D moves while driving to change a driving posture, the positions of the left and right eyes of the driver are changed, so that the three-dimensional image 312 output from the B region 321b of the liquid crystal panel 321 may be recognized separately into the left eye image and the right eye image, respectively.

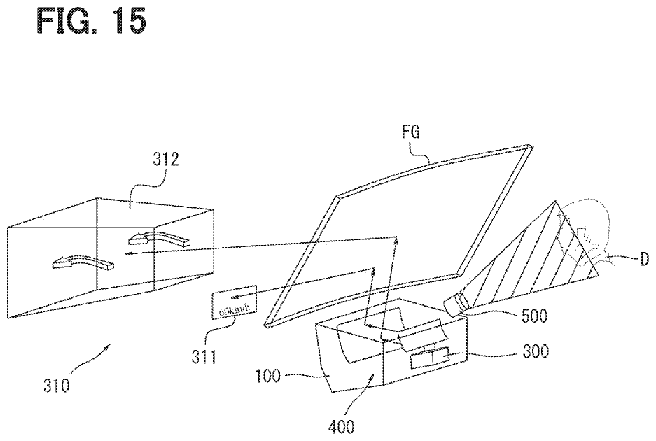

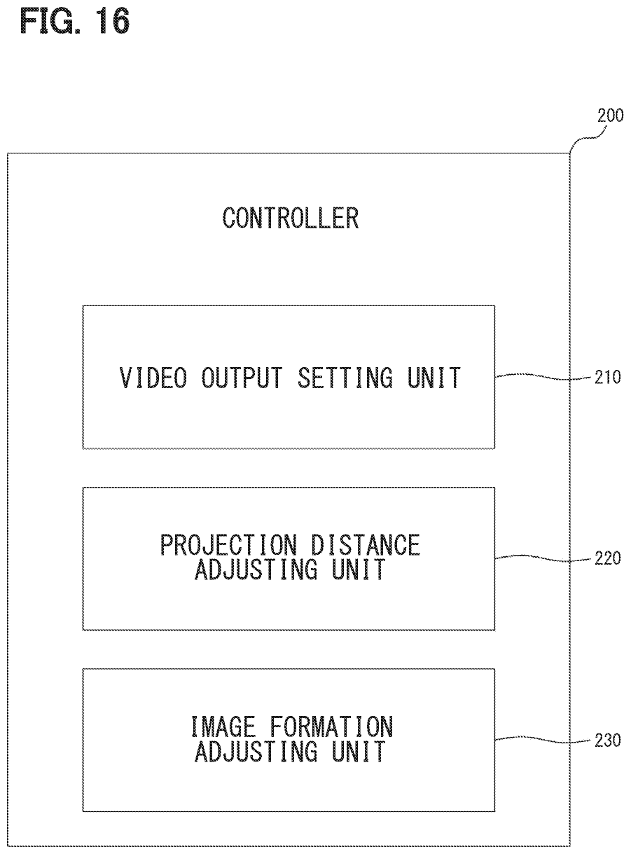

Therefore, in order to supplement the problem described above, as illustrated in FIG. 15, a binocular detection sensor 500, which detects the movements of the left and right eyes of the driver D, may be further provided. In this case, as illustrated in FIG. 16, the controller 200 may further include an image formation adjusting unit 230 which receives a signal from the binocular detection sensor 500 to control the optical path of the optical unit 400, so that the image output from the B region 321b of the liquid crystal panel 321 is displayed as the three-dimensional image 312 to the driver D according to the movements of the left eye and the right eye of the driver D.

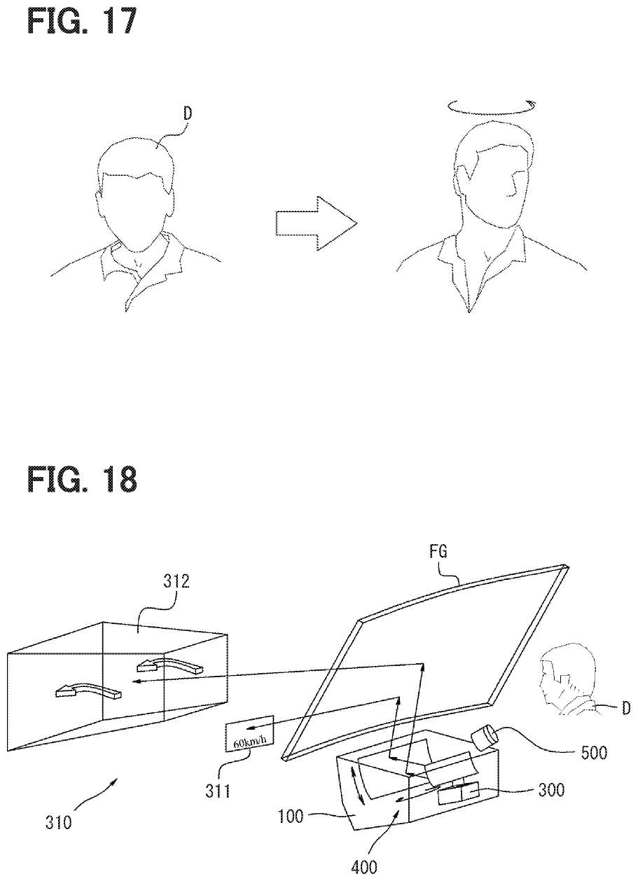

That is, as illustrated in FIGS. 17 and 18, when the driver D turns his/her face to check side mirrors provided on the left and right sides of the vehicle, moves the field of view to the front of the vehicle, and then moves to the front of the field of view, the positions of the left eye and the right eye of the driver D are moved. Therefore, a situation is generated, in which the image output from the B region 321b of the liquid crystal panel 321 is separated into the left and right eye images respectively to be recognized. Therefore, as illustrated in FIG. 18, when the movement is detected by detecting the movements of the left and right eyes of the driver D by the binocular detection sensor 500, a signal is transmitted to the image formation adjusting unit 230 and thereby the image formation adjusting unit 230 controls the optical unit 400. Therefore, the driver D recognizes the image output from the B region 321b of the liquid crystal panel 321 displayed on the windshield FG of the vehicle as the three-dimensional image 312.

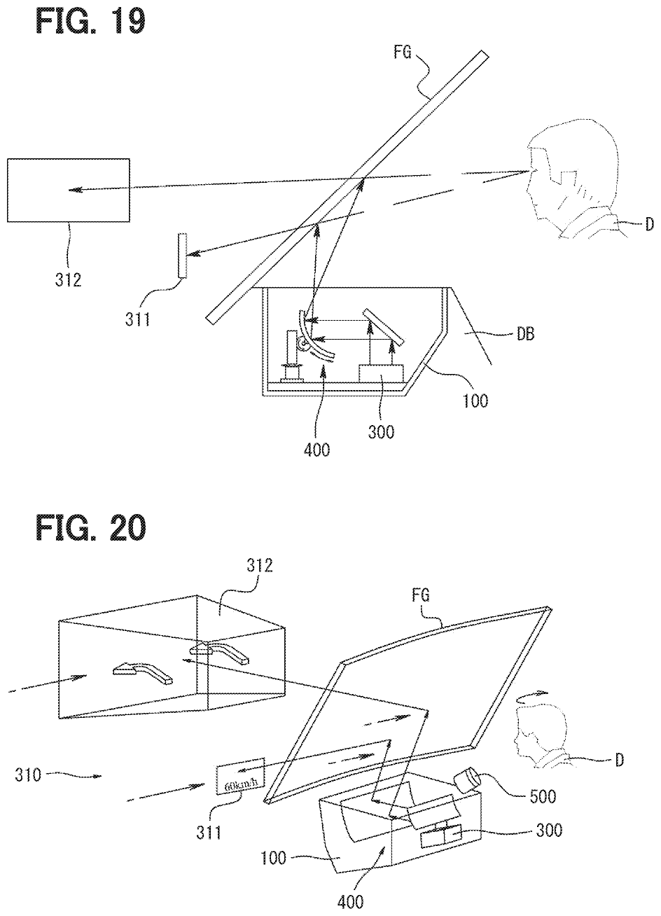

In this case, the binocular detection sensor 500 may be a camera that captures the face of the driver D and stores the image as a still image, or may be an infrared ray sensor (IR sensor) using infrared light. In addition, as illustrated in FIG. 19, the optical unit 400 may further include a projection adjusting module (not illustrated) for rotating the concave mirror up and down according to a control signal of the projection distance adjusting unit 220, and an image adjusting module for rotating the concave mirror to the left and right by rotating the projection adjusting module to the left and right according to a control signal of the image formation adjusting unit 230.

That is, when the movements of the left and right eyes of the driver D are detected by the binocular detection sensor 500, a detection signal is transmitted to the image formation adjusting unit 230, and thereby the image formation adjusting unit 230 controls an optical path of the optical unit 400. Therefore, as illustrated in FIG. 20, the image output from the B region 321b of the liquid crystal panel 321 is displayed for the driver D as the three-dimensional image 312 according to the movements of the left and right eyes of the driver D. In this case, the planar image 311 outputted from the A region 321a of the liquid crystal panel 321 is also moved according to a change in the optical path of the optical unit 400, so that the driver D can easily recognize not only the three-dimensional image 311 but also the planar image 311 output from the video output unit 300.

Here, as described above, the optical unit 400 is controlled so that the driver D recognizes the image output from the B region 321b of the liquid crystal panel 321 as the three-dimensional image 312 by detecting the movements of the left and right eyes of the driver D by the binocular detection sensor 500. However, in a case of a situation in which the driver D is sitting in the driver's seat and does not drive the vehicle while looking the front of the vehicle, for example, not in a case in which the left and right eyes of the driver D are moved by moving the body of the driver D while driving, but in case in which after the driver D stops the vehicle, and opens a glove box in a passenger seat next to the driver's seat to take out an article, or a case in which the face of the driver D moves toward the center fascia to operate the navigation provided in the center fascia of the vehicle, it is not necessary to control the optical unit 400 by the image formation adjusting unit 230.

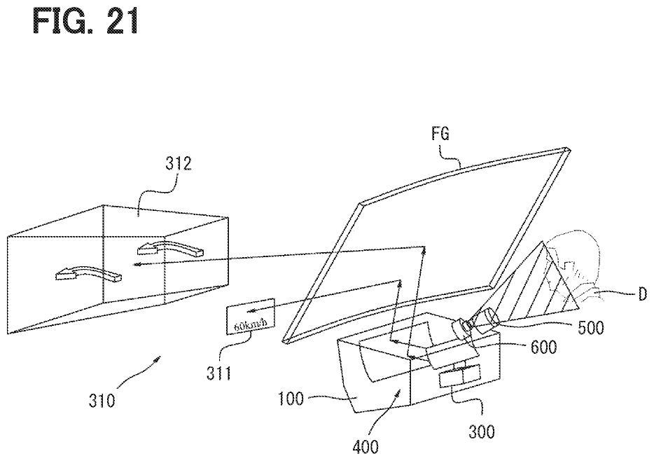

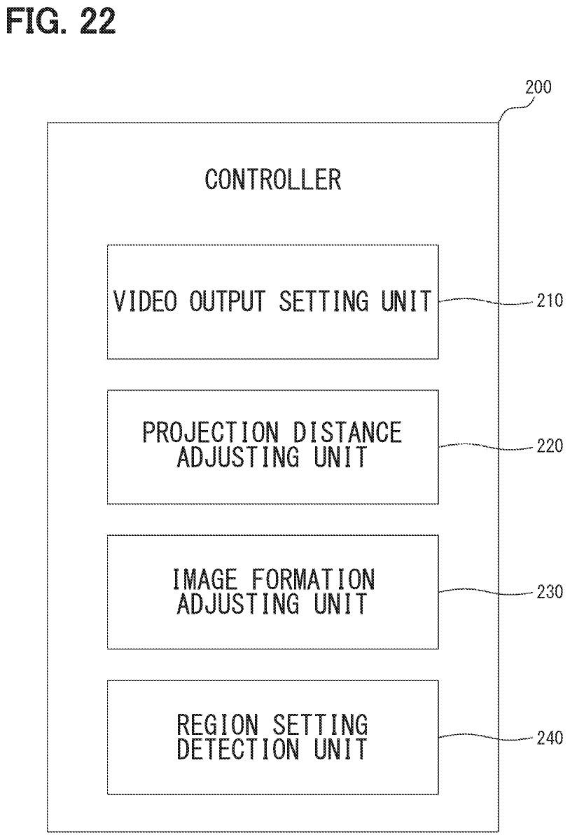

Therefore, as illustrated in FIG. 21, the controller may further provide a region setting sensor 600 for photographing the fixed tracking region 610 including the face of the driver D when the driver D is in the driver's seat of the vehicle. In this case, as illustrated in FIG. 22, the controller 200 may further include a region setting detection unit 240 for controlling the optical path of the optical unit 400, so that the tracking region 610 of the region setting sensor 600 is set and if the face of the driver D leaves the tracking region 610, the image output from the B region 321b of the liquid crystal panel 321 is displayed at a preset setting position.

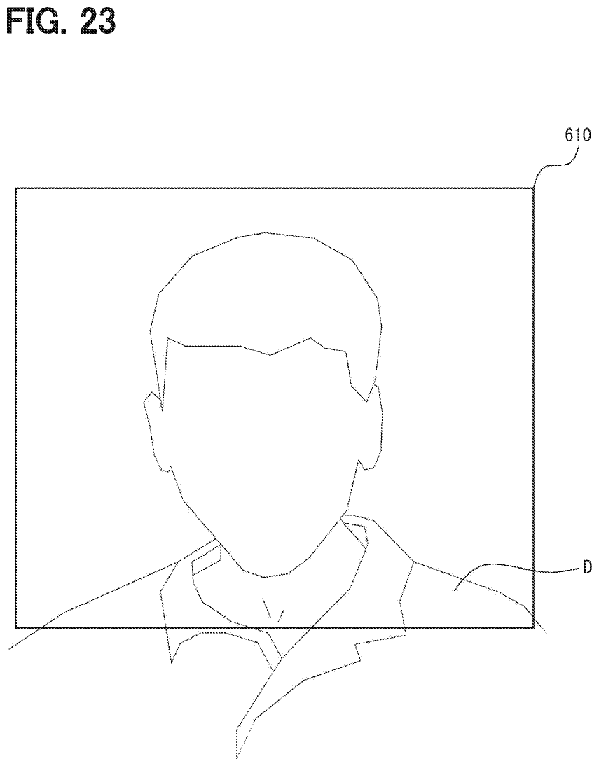

That is, as illustrated in FIG. 23, the region setting sensor 600 is provided for photographing the tracking region 610 including the face of the driver D and a surrounding region of the face when the driver D is in the driver's seat of the vehicle and looks forward. In this case, since the shape and size of the face vary depending on the driver D, the tracking region 610 may decrease or increase a detection range by the region setting detection unit 240. In addition, the region setting sensor 600 may be a camera that photographs the face of the driver D and the surrounding region of the face.

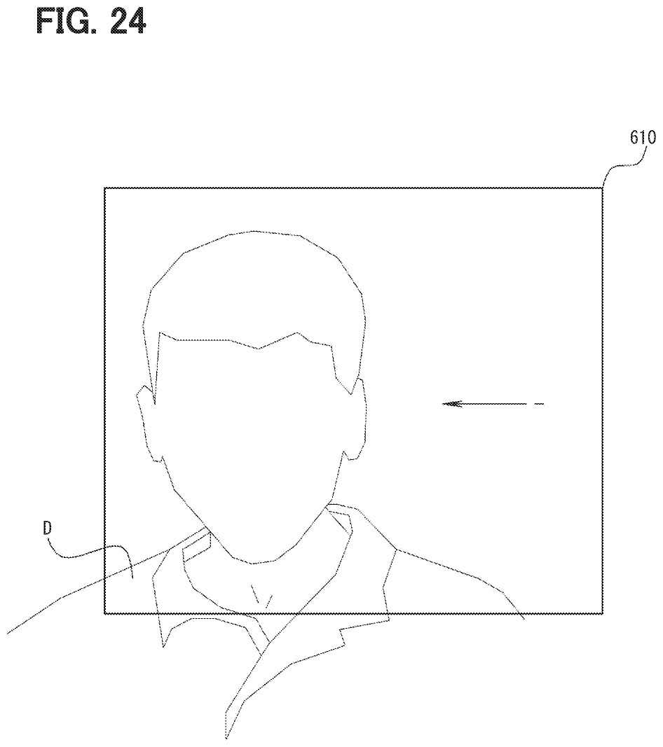

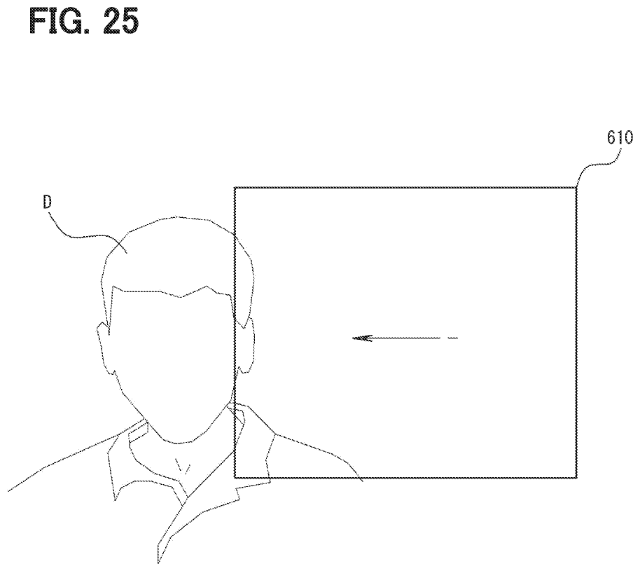

Therefore, as illustrated in FIG. 24, when the driver D moves within the tracking region 610 of the region setting sensor 600, as illustrated in FIG. 20, the binocular detection sensor 500 detects the movements of the left and right eyes of the driver D. Therefore, the optical unit 400 is controlled so that the image output from the B region 321b of the liquid crystal panel 321 is recognized as the three-dimensional image 312. As illustrated in FIG. 25, when the driver D moves out of the tracking region 610 of the region setting sensor 600, the optical unit 400 is controlled, so that the image output from the B region 321b of the liquid crystal panel 321 is displayed at a preset setting position.

In this case, as illustrated in FIG. 23, when the driver D rides in the driver's seat of the vehicle and sets the tracking region 610 of the region setting sensor 600 for the first time, the preset setting position may be the optical path of the optical unit 400 which is controlled so that the image output from the B region 321b of the liquid crystal panel 321 is output as the three-dimensional image 312, or may be a setting position separately set by the driver D.

As described above, the head-up display system according to the present disclosure divides one image panel 321 into the A region 321a and the B region 321b to output the planar image 311 to the A region 321a and output the three-dimensional image 312 to the B region 321b. Therefore, the overall size of the device is decreased and the image information of the size capable of being easily checked by the driver D is output. In particular, the driving safety and convenience of the driver D can be maximized by providing further accurate information by the three-dimensional image 312.

Also, each of the images 311 and 312 output from the video output unit 300 is turned on/off or the projection distance is adjusted by the video output setting unit 210 and the projection distance adjusting unit 220 depending on the driver D. Therefore, the driver D easily checks the driving information of the vehicle output from the video output unit 300. The optical path of the optical unit 400 is controlled, so that the driver D recognizes the image output from the B region 321b of the liquid crystal panel 321 through the image formation adjusting unit 230 and the region setting detection unit 240 as the three-dimensional image 312. Therefore, the driver D easily checks the 3D driving information output from the B region 321b of the liquid crystal panel 321, thereby further maximizing driving safety and convenience of the driver D.

The embodiments of the present disclosure described above and illustrated in the drawings should not be construed as limiting the technical idea of the present disclosure. The protection scope of the present disclosure is limited only by the matters described in the claims, and those skilled in the art can improve and change the technical idea of the present disclosure in various forms. Therefore, such improvements and changes will fall within the protection scope of the present disclosure, as will be apparent to those skilled in the art.

What is claimed is:

1. A head-up display system comprising:
a housing that is to be embedded in an upper portion of a dashboard of a vehicle;
a controller that is configured to receive driving information from the vehicle and to store the driving information;
a video output unit that is installed inside the housing and is configured to receive the driving information from the controller and to output and project a plurality of separated videos; and
an optical unit that is installed inside the housing and is configured to change an optical path of each of the videos projected from the video output unit, so that the respective videos are projected and displayed at different projection distances on a windshield of the vehicle.

2. The head-up display system according to claim 1,
wherein the video output unit includes a liquid crystal module that includes a liquid crystal panel and a backlight unit disposed on a back of the liquid crystal panel, and
wherein the liquid crystal panel includes a first region that outputs the driving information received from the controller as a planar image and a second region that outputs the driving information as a three-dimensional image.

3. The head-up display system according to claim 2,
wherein the liquid crystal module is provided with a parallax barrier film in the second region,
wherein the driving information output from the second region of the liquid crystal panel as an image is separated into a left eye image and a right eye image different from each other according to a binocular parallax of left and right eyes of a driver, thereby to be displayed as the three-dimensional image.

4. The head-up display system according to claim 2,
wherein the controller includes a video output setting unit that is configured to receive a control signal from the video output unit and to individually turn on or off an image output from each of the first region and the second region of the liquid crystal module.

5. The head-up display system according to claim 2,
wherein the controller includes a projection distance adjusting unit that is configured to control an optical path of the optical unit to adjust a projection distance of the image output from each of the first region and the second region of the liquid crystal module to be displayed on the windshield of the vehicle through the video output unit.

6. The head-up display system according to claim 3, further comprising:
a binocular detection sensor that is configured to detect movements of the left and right eyes of the driver,
wherein the controller includes an image formation adjusting unit that is configured to receive a signal from the binocular detection sensor and to control an optical path of the optical unit, so that the image output from the second region of the liquid crystal panel is displayed for the driver as the three-dimensional image according to the movements of the left and right eyes of the driver.

7. The head-up display system according to claim 5, further comprising:
a region setting sensor that is configured to photograph a fixed tracking region including a face of the driver in a driver's seat of the vehicle,
wherein the controller further includes a region setting detection unit that is configured to set a tracking region of the region setting sensor and to control the optical path of the optical unit, so that the image output from the second region of the liquid crystal panel is displayed at a preset setting position when the face of the driver leaves the tracking region.
